(19) United States
(12) Patent Application Publication
(10) Pub. No.: US 2002/0173359 A1
(43) Pub. Date: Nov. 21, 2002

(54) Modular video game

(76) Inventors: Augusline M. Gallo, Las Vegas, NV (US); Michelle D. Casler, Las Vegas, NV (US)

Correspondence Address: Donald J. Ersler, 725 Garvens Avenue, Brookfield, WI, 53005, US

(21) Appl. No.: 09/855,264

(22) Filed: May 16, 2001

(51) Int. Cl. A63F 13/00

(52) U.S. Cl. 463/43

(57) ABSTRACT

A modular video game includes a software program which is adapted to play on a particular hardware platform. The software program is installed on the hardware platform. The software program has the ability to read files through storage devices, or through connecting with an external device. The modular video game allows concert music and graphics to be entered from an external source. Advertising spaces exist within the game to allow various companies to offer targeted advertisements. The modular video game may also be offered on a one time play basis. The game characters, background music, and other elements may be chosen from a list. A preferable embodiment of the modular video game is an action game which starts at the entrance of a music concert and has a final goal of making it on to a stage with player's favorite music artist(s).

### BACKGROUND OF THE INVENTION

1. Field of the Invention

The present invention relates generally to video games and more specifically to a video game which allows modular selection of game elements, selection of music with the corresponding music artist, and changeable advertising spaces within the game.

2. Discussion of the Prior Art

There are numerous video games on the market. However, it appears that none of these video games allow a player to choose musical artists, popular persons, music groups, or others as characters within the game. Further, it also appears that no video game exists which allows a player to choose music with the corresponding music artist to be played during the game. Additionally, it also appears that no video game exists which is capable of receiving both new music and video material from a storage device which changes the substance of the game. Finally, it also appears that no video game exists which provides advertising spaces within the game that are capable of being filed with different advertising.

Accordingly, there is a clearly felt need in the art for a video game which allows modular selection of musical artist, popular persons, music groups, or others as characters from an external source, selection of music with the corresponding artist, and the ability to sell changeable advertising space within the game for companies to advertise their products.

### SUMMARY OF THE INVENTION

The present invention provides a video game with the choice of game characters, the choice of music, and the ability for others to advertise therein. The modular video game includes a software program which is adapted to play on a particular hardware platform. The hardware platform could be a personal computer, Playstation 2 console, Microsoft X-box console, or any other suitable device. The hardware platform must be capable of reading storage devices and preferably capable of downloading from an external database. The software program is preferably developed utilizing an existing game engine to reduce the amount of programming time. It is preferable to use the C++ software language for further additions to the game engine.

Music may be chosen according to a player's taste. It is preferable to use some type of storage device such as a compact disc (CD) which will have both music and the video files of the artist. The CD will preferably have popular songs from at least two different artists with video files. Regular music CDs could also be used. The video files would be downloaded from an external database such as the Internet. Further, the music may be supplied by a compressed audio file. The compressed audio file could be MP3 or any other suitable compressed audio format. It is preferable to have concert venues which may be chosen according to the player's taste. Each concert venue will have a different level of difficulty. Each artist may play at any concert venue. Game characters may also be chosen according to a player's taste.

It is preferable to offer the ability to advertise products within the game to provide a further source of revenue for the manufacturer of the game. Advertisers could buy advertising space on optional storage devices. The program software would scan the storage device for a file containing the advertising information. If no advertising information is found on the new storage device, the program software would read in at least one default advertising file. The advertisements could be displayed on billboards, television screens, banners, and any other suitable surface within the concert venue.

One time play may also be offered through download from an external source. The musical artists may be chosen from an available list in conjunction with favorite songs. The advertisers will be able to pay on a per viewed basis. The advertisers only pay for the number of times that the game is played. The artist or music group is paid for the number of times the game is played. The manufacturer or licensor of the game may also be paid for the number times that the game is played.

A preferable embodiment of the modular video game is an action game which has a goal of a play character making it on to the concert stage where the artist or music group is performing. First, the play character passes through the concert venue entrance, then the play character must overcome different obstacles to make it to the mosh pit. Next, the play character must pass through the mosh pit and overcome different obstacles in the mosh pit. Finally, the play character makes it on to the main concert stage. The player must determine how to overcome the obstacles and master gaming techniques to quickly move through the obstacles on each level. If the play character is able to make it on to the stage before the timer expires, the player may be able to advance to a more difficult concert venue with choice of a particular artist or music group. It is preferable to offer a choice of existing concert venues such as stadiums and auditoriums throughout the United States. It is also preferable that the closer the play character comes to the stage, the louder the music becomes, and the larger and more focused the characters on stage become.

Accordingly, it is an object of the present invention to provide a modular video game which allows a player to have a choice of music with the graphic representation of the corresponding artist or music group.

It is a further object of the present invention to provide a modular video game which allows a player to have a choice of game characters and objects.

Finally, it is another object of the present invention to provide a modular video game which provides changeable advertising spaces for others to advertise therein.

These and additional objects, advantages, features and benefits of the present invention will become apparent from the following specification. dr

### BRIEF DESCRIPTION OF THE DRAWINGS

FIG. 1 is a first page of a flow chart of a modular video game in accordance with the present invention.

FIG. 2 is a second page of a flow chart of a modular video game in accordance with the present invention.

FIG. 3 is a third page of a flow chart of a modular video game in accordance with the present invention.

### DETAILED DESCRIPTION OF THE PREFERRED EMBODIMENTS

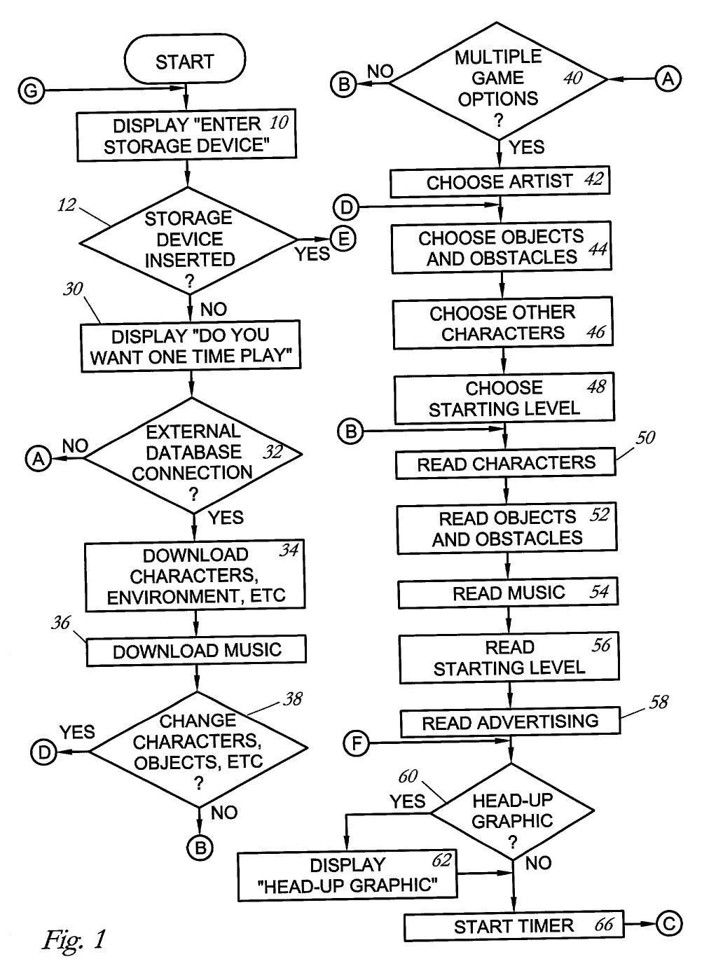

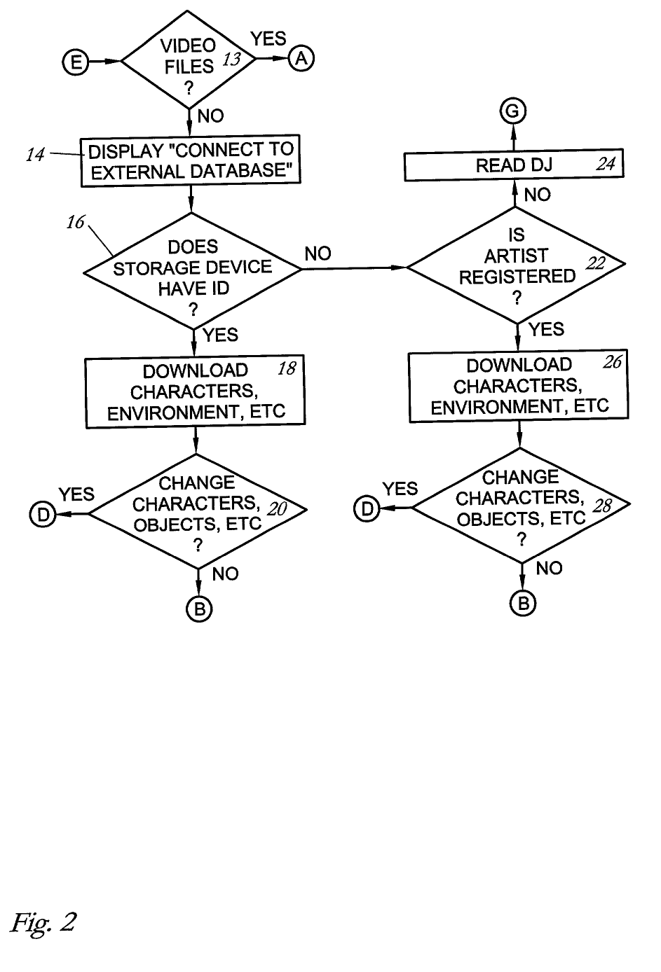

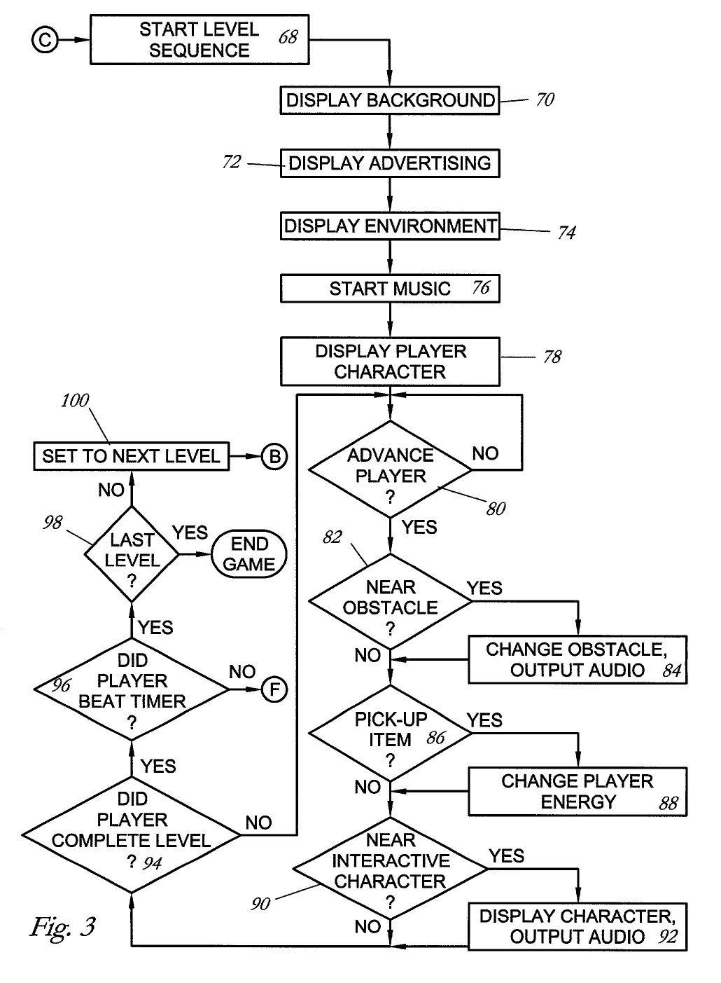

With reference now to the drawings, and particularly to FIGS. 1-3, there is shown a flow chart of a modular video game. The modular video game includes a software program which is adapted to play on a particular hardware platform. The hardware platform could be a personal computer, Playstation 2 console, Microsoft X-box console, or any other suitable device. The hardware platform must have the ability to read storage devices, and preferably capable of downloading from an external database. The storage device could be compact discs, videodiscs, or any other suitable storage device. The external database is preferably the Internet, but other external databases may also be used. The software program is preferably developed utilizing an existing game engine such as the UNREAL game engine manufactured by Epic Games to reduce the amount of programming time. It is preferable to use the C++ software language for further additions to the game engine.

There are preferably five types of game characters, namely a play character, musician characters, interactive characters, noninteractive characters and background characters. The player preferably has a choice of play characters which have different appearances and different strengths. Some different strengths could include the ability to jump higher than others, kick better, run faster, maneuver better, or any other appropriate strength. The musician characters are the musicians on the stage playing the music. The musician characters will have physical movements such as playing instruments or singing that are coordinated with the music being played. The movement of each musician will duplicate that seen at a real concert. The musician characters have a likeness which is as close as possible to the real musician. The interactive characters will have some type of contact with the play character. For example an interactive character will try to stop the play character from advancing to the end of the level. The noninteractive characters do not contact the play character, but may engage in some activity such as jumping up and down or throwing an object. The background characters for example are the audience and may move slightly or change facial expressions.

A preferable embodiment of the modular video game is a “mosh pit” video game which has a goal of a play character making it on to the concert stage where the artist or music group is performing. The movements of the musician characters are preferably coordinated with the music being played. First, the play character passes through the concert venue entrance, then the play character will have to pass through isles and walk down stairs where they must overcome different obstacles to make it into the mosh pit. The obstacles on the way to the mosh pit include crazed fans, flying objects, merchant vendors, gangs, and overzealous security guards. Next, the play character may make it into the most pit by jumping from higher levels. Then the play character must make it through the mosh pit and overcome different obstacles in the mosh pit. The obstacles in the mosh pit include slam dancers, fights, and bouncers. The play character may make it through the most pit by crowd surfing or stage diving. Finally, the play character makes it on to the main concert stage. The player must determine how to overcome the obstacles and master gaming techniques to quickly move through the obstacles on each level.

The game may be intensified by requiring that the player reach the concert stage in a limited amount of time with a certain number of points. The player may get extra points by finding hidden items including drum sticks, guitar picks, cell phones, two way pagers, lighters, and neon glow sticks. A bonus item includes finding a back stage pass. The play character will then be able to go back stage where they may be able to meet the artist or group musicians.

If the player advances in an extraordinary amount of time, the player may be able to advance to a more difficult concert venue with choice of artist or music group. The player may also gain extra points by crowd surfing, stage diving, obtaining backstage passes, meeting band members, finding hidden items, or any other suitable reward. It is preferable to offer a choice of existing concert venues such as stadiums and auditoriums throughout the United States. It is also preferable that the closer the play character comes to the stage, the louder the music becomes, and the larger and more focused the characters on stage become. Once the play character makes it on stage, preferably the whole screen is taken up with the concert stage.

A flow chart illustrates the above preferred embodiment of the “mosh pit” video game. The flow chart in FIGS. 1-3, illustrate a preferable software sequence of operations. Other sequences for the execution of the program code may also be used. The description of the program is also not exhaustive. In process block 10 the player is prompted to enter a storage device containing music and/or video into the hardware platform. If a storage device is inserted in decision block 12, the storage device is examined to see if it has video files in decision block 13. If the storage device has video files, the program goes to decision block 40. If the storage device does not have video files, the program assumes that the storage device only contains audio information. The player is then prompted to connect to an external database such as the Internet in process block 14. It is also preferable to have a storage device with only the music of a particular artist or group. Further, a storage device could have a single concert venue with groups who play that concert venue.

Some hardware platforms do not have the capability of connecting to the Internet and will not be able to obtain information therefrom. The storage device is examined to detect an identification string in decision block 16. If the storage device has an identification string, characters, environment, background, obstacles, objects and other graphical information will be downloaded from the external database (such as the Internet) to the hardware platform in process block 18. The appearance of the musician characters will be chosen by the artist or music group. The graphical information will replicate the on stage appearance and performance of the artist or music group. Characters, obstacles, or objects contained within the download may be changed to suit the players taste in decision block 20.

If the storage device does not have an identification string, the external database will be searched to see if the artist or music group has registered with the game maker in decision block 22. If the artist or music group has not registered with the game maker, a generic disc jockey will be displayed with a message that the artist or music group is not registered and to please make another selection. The program will then loop back to process block 10. If the artist is registered, whatever characters, environment, obstacles, and objects the artist provides will be downloaded from the external database in process block 26. The player will be given the opportunity to change the characters, obstacles, and objects to suit their taste in decision block 28.

If a storage device is not inserted into the hardware platform, the player is prompted with a “do you want one time play” in process block 30. The player makes a decision for one time in decision block 32. One time play through an external database (such as the Internet) offers numerous play options which are not available through the purchase of storage devices. The players do not have to make numerous purchases to obtain a variety of musical artists. The players will pay only for the times that they actually play the game. The players may choose different musical artists each time or the same musical artist each time. Advertisers will be able to pay on a per viewed basis. The characters, environment, background, obstacles, objects, and other information will be downloaded from the Internet to the hardware platform in process block 34. The music is downloaded from the Internet through a compressed audio format such as MP3 in process block 36. The characters, obstacles, or objects may be changed to suit the player's taste in decision block 38. The audio and video files downloaded from the external database will be deleted after the one time play is completed.

If the player does not have a new storage device or does not desire “one time play,” the program prompts the player to choose game options in decision block 40. If multiple game options exist, the player may choose any or all of them. When ever the player chooses to change an element, they will have the option of changing the artist in process block 42, objects and obstacles in process block 44, characters in process block 46, and starting level in process block 48.

Next the program reads the chosen characters in process block 50, the chosen objects and obstacles in process block 52, the chosen music in process block 54, the starting level in process block 56, and the advertising source in process block 58. It is preferable to offer companies the ability to advertise products within the game to provide a further source of revenue for the manufacturer of the game. The artist or music group may also be able to fill advertising spaces in the game with advertiser(s) whom they have affiliations. If unique advertising is not obtained from a storage device or from an external database download, a file containing default advertising is read into the program.

The default advertising could be sold according to a particular geographic region of the country or simply on a blanket geographic basis. Advertisers would buy advertising space for a particular artist package contained on a storage device or downloaded from the external database. Another advertiser option is to have fixed advertising that appear in all levels of a particular upgrade storage device. However, other methods of selling advertising may also be used. The program would read a storage device or an external database download for a file containing advertising information. If no advertising information is found, the program would read in and display the default advertising file. The advertisements could be displayed on billboards, television screens, banners, and any other suitable surface within the game.

Next, the player is prompted with the option of a head-up graphic which displays the energy level, score, and play level of the player in decision block 60. The head-up graphic is displayed in process block 62. The timer is started in process block 66. The level sequence is started in process block 68; the background is displayed in process block 70; the advertising is displayed in process block 72; the environment is displayed in process block 74, the music is activated in process block 76, and the play character is displayed in process block 78.

If the program receives input, the play character is advanced in decision block 80. If the play character is near an obstacle in decision block 82, the obstacle interacts with the play character in process block 84 with the appropriate video and audio. The play character has an opportunity to pick-up items in decision block 86. The items that can be picked-up for energy will be shown on the screen before the game or level begins and in the head-up graphic. Some items will be more difficult to find than others. Preferably, the harder the item is to find, the more energy it will provide the play character. All items will be hidden and placed randomly. If the play character picks-up an item its energy level is changed in process block 88. If the play character is near an interactive character in decision block 90, the interactive character interacts with the play character in process block 92 with the appropriate video and audio.

If the level is not completed, the program goes back to the beginning of the play loop in process block 94. If the level was completed, the timing of the play is checked in decision block 96. If the player did not beat the timer, the program loops back and restarts the level. If the player did beat the timer, the last level of play is checked in decision block 98. If the last level was not completed, the program is set to the next level of play in process block 100. If the last level was completed, the game ends.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of operating a modular video game having user selectable music concerts comprising the steps of:
(a) providing a hardware platform with at least one device for reading a storage device, said storage device containing at least one audio file;
(b) programming said hardware platform with a software program which reads a storage device, said storage device containing music;
(c) reading said storage device with said at least one device for reading a storage device, information on said storage device being read by said external database, said external database downloading at least one video file in response to the information on said storage device to said hardware platform; and
(d) providing the option of changing elements in said video files.

2. The method of operating a modular video game having user selectable music concerts of claim 1 wherein:
said external database being the Internet.

3. The method of operating a modular video game having user selectable music concerts of claim 1, further comprising the steps of:
(e) consulting said external database to see if the artist of the music contained on said storage device has at least one related video file.

4. The method of operating a modular video game having user selectable music concerts of claim 3, further comprising the steps of:
(f) downloading said at least one related video file to said hardware platform, if said at least one related video file exists.

5. The method of operating a modular video game having user selectable music concerts of claim 1, further comprising the steps of:
(e) the information contained on said storage device comprising an embedded identification number, said external database reading said identification number and providing the download of at least one video file.

6. The method of operating a modular video game having user selectable music concerts of claim 1, further comprising the steps of:
(e) the information contained on said storage device comprising the name of the artist or music group, said external database reading the information and providing the download of at least one video file.

7. The method of operating a modular video game having user selectable music concerts of claim 1, further comprising the steps of:
said modular video game providing the capability of allowing elements to be changed.

8. The method of operating a modular video game having user selectable music concerts of claim 1, further comprising the steps of:
said modular video game providing different play characters, each said play character having a unique strength.

9. The method of operating a modular video game having user selectable music concerts of claim 1, further comprising the steps of:
each level of play occurring in a different existing concert venue.

10. The method of operating a modular video game having user selectable music concerts of claim 1, further comprising the steps of:
musician characters on a main stage becoming larger and more focused the closer the play character gets to the main stage, music becoming louder as the play character gets closer to the main stage.

11. The method of operating a modular video game having user selectable music concerts of claim 1, further comprising the steps of:
movement of musician characters being coordinated with the play of said at least one audio file.

12. A method of operating a modular video game having user selectable elements comprising the steps of:
(a) providing a hardware platform with at least one device for reading a storage device;
(b) programming said hardware platform with a software program which reads a storage device, said storage device containing at least one audio file and at least one video file; and
(c) providing a choice of changing at least one element of said modular video game, movement of musician characters being coordinated with the play of said at least one audio file.

13. The method of operating a modular video game having user selectable elements of claim 12 wherein:
said at least one different element being a play character.

14. The method of operating a modular video game having user selectable elements of claim 12 wherein:
said at least one different element being the music played during the modular video game.

15. The method of operating a modular video game having user selectable elements of claim 12 wherein:
said at least one different element being objects and obstacles encountered during the modular video game.

16. A method of operating a modular video game having the ability to receive different advertising messages comprising the steps of:
(a) providing a hardware platform with at least one device for reading a storage device;
(b) programming said hardware platform with a software program which reads a storage device, said storage device containing at least one audio file;
(c) creating at least one advertising surface within a play environment of said modular video game, each said advertising surface receiving one advertising message;
(d) providing at least one least one advertising message file, said at least one advertising message file being included with at least one specific file which is selectively supplied to said modular video game; and
(e) supplying at least one default advertising file which is inserted into said at least one advertising surface if another advertising message file is not available.

17. The method of operating a modular video game having the ability to receive different advertising messages of claim 16 wherein:
said at least one advertising file being included with a download of at least one video file.

18. The method of operating a modular video game having the ability to receive different advertising messages of claim 16 wherein:
said at least one advertising file being included on a storage device.

19. A method of operating a modular video game having user selectable music concerts for one time play comprising the steps of:
(a) providing a hardware platform which is capable of being connected to an external database;
(b) programming said hardware platform with a software program which is capable of downloading information from an external database;
(c) making a connection between said external database and said hardware platform, downloading at least one audio file and at least one video file containing musician characters which have movement which is coordinated with the play of said at least one audio file; and
(d) said at least one audio file and said at least one video file being deleted after the one time play has ended.

20. The method of operating a modular video game having user selectable music concerts for one time play of claim 19 wherein:
said external database being the Internet.

21. The method of operating a modular video game having user selectable music concerts for one time play of claim 19 wherein:
said modular video game providing the capability of allowing elements to be changed.

22. The method of operating a modular video game having user selectable music concerts for one time play of claim 19 wherein:
said modular video game providing different play characters, each said play character having a unique strength.

23. The method of operating a modular video game having user selectable music concerts for one time play of claim 19 wherein:
each level of play occurring in a different existing concert venue.

24. The method of operating a modular video game having user selectable music concerts for one time play of claim 19 wherein:
musician characters on a main stage becoming larger and more focused the closer the play character gets to the main stage, music becoming louder as the play character gets closer to the main stage.
